(19) United States
(12) Patent Application Publication
(10) Pub. No.: US 2026/0170485 A1
(43) Pub. Date: Jun. 18, 2026

(54) PRELOADING CREDENTIAL PAYLOAD TO WALLET ACCORDING TO CONTEXT ANALYSIS

(71) Applicants: American Express Travel Related Services Company, Inc., New York, NY (US); AMEX Canada, Inc., North York (CA)

(72) Inventors: Magdalena McGoldrick, East York (CA); Margaret H. Ryan, Jersey City, NJ (US); Ashley Sjostrom Brailey, Garwood, NJ (US); Alaric M. Eby, Scottsdale, AZ (US)

(21) Appl. No.: 18/984,369

(22) Filed: Dec. 17, 2024

(51) Int. Cl. G06Q 20/36; G06F 21/31

(52) U.S. Cl. CPC G06Q 20/3674; G06F 21/31; G06Q 20/363

(57) ABSTRACT

Disclosed are various embodiments for recommending digital credentials for a user to present at a terminal based at least in part on an informed hypothesis of the context surrounding the terminal and user. A user can store multiple types of credentials (e.g., payment account data, coupons, tickets, identification, etc.) in a digital wallet. A trained recommendation model can be executed to make an informed hypothesis of what context may be sought by a terminal and what credential should be presented at the terminal by analyzing data associated with the given context. A credential payload associated with the recommended credential can be generated and preloaded by the wallet so that the user can present the recommended credential to the terminal without having to select which credential to present.

### BACKGROUND

Digital wallets allow users to store multiple types of credentials (e.g., payment account data, coupons, tickets, identification, etc.) in a central location. The credentials can be used to allow the user to make contactless transactions with his or her mobile device using a selected transaction. When there are multiple stored credentials, the user may have to navigate through the representations of each of the stored credentials to find the appropriate credential to present to a terminal at a given time. In addition, with respect to payment credentials, users require significant foresight to navigate payment credential selection to maximize card product benefit utilization.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B are drawing depicting several embodiments of the present disclosure.

FIGS. 2A and 2B are drawings of example networked environments according to various embodiments of the present disclosure.

FIG. 3 is a sequence diagram illustrating examples of functionality in the offline task environment of FIG. 2A according to various embodiments of the present disclosure.

FIG. 4 is a flowchart illustrating one example of functionality implemented as portions of a wallet application executed in a client device in the network environment of FIG. 2B according to various embodiments of the present disclosure.

FIG. 5 is a flowchart illustrating one example of functionality implemented as portions of a wallet application executed in a client device in the network environments of FIGS. 2A and 2B according to various embodiments of the present disclosure.

FIG. 6 is a flowchart illustrating one example of functionality implemented as portions of a wallet application executed in a client device in the network environments of FIGS. 2A and 2B according to various embodiments of the present disclosure.

### DETAILED DESCRIPTION

Disclosed are various approaches for recommending digital credentials for a user to present at a terminal based at least in part on an informed hypothesis of the context surrounding the terminal and user. A user can store multiple types of credentials (e.g., payment account data, coupons, tickets, identification, etc.) in a digital wallet. According to various examples, a trained recommendation model can be executed to make an informed hypothesis of what context may be sought by a terminal (e.g., payment, loyalty account creation, event ticket presentment, identity authentication, etc.) and what credential should be presented at the terminal by analyzing input data (e.g., user interaction data, loyalty engagement data, user data, geolocation, event or calendar data, card benefits, terminal data, credential data, etc.) associated with the given context. A credential payload associated with the recommended credential can be generated and preloaded by the wallet so that the user can present the recommended credential to the terminal without having to select which credential to present.

Typically, when there are multiple stored credentials in a digital wallet, the user needs to navigate through the multiple visual representations of each of the stored credentials to find the appropriate credential to present to a terminal at a given time. In addition, with respect to payment credentials, the user may not have the appropriate foresight to navigate payment credential selection to maximize card product benefit utilization. According to various examples, the present disclosure provides a solution to this problem by hypothesizing what credentials are needed for a terminal presentation based at least in part on an analysis of context data, terminal data, and/or other types of data, and preloading the wallet with a payload associated with the recommended credentials without the user having to make the selection. The preloaded payload can be used to answer the questions a terminal may have for the device when a direct wireless communication is established between the terminal and the user device.

According to various examples, a trigger event can be detected that can indicate a future terminal interaction with a user's device. The trigger event can be based at least in part on a time, a location, prior behavior, user defined settings, transaction data, an opening of a wallet application, terminal data, and/or other types of data. In some examples, the trigger event is detected based at least in part on an analysis of real-time user and device data using predication algorithms and/or prediction models. In other examples, the trigger can be detected in response to the occurrence of a given action, time, and/or date. Upon detection of the trigger event, a credential can be recommended based at least in part on an analysis of the context associated with the future terminal interaction.

In various examples, a recommendation model for recommending a credential for future terminal interaction can be trained using historical and/or real time data. In various examples, the recommendation model is trained to analyze to analyzing input data (e.g., user interaction data, loyalty engagement data, user data, geolocation, event or calendar data, card benefits, terminal data, credential data, etc.) to make an informed hypothesis of what context may be sought by a terminal (e.g., payment, loyalty account creation, event ticket presentment, identity authentication, etc.) and what credential should be presented at the terminal. In some examples, the recommendation model is trained, stored, and executed on a backend device and a client device can interact with the backend device to obtain recommended credentials in response to detecting a trigger event. In other examples, the recommendation model is trained regularly on a backend device and pushed down to a client device for execution on the client device.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

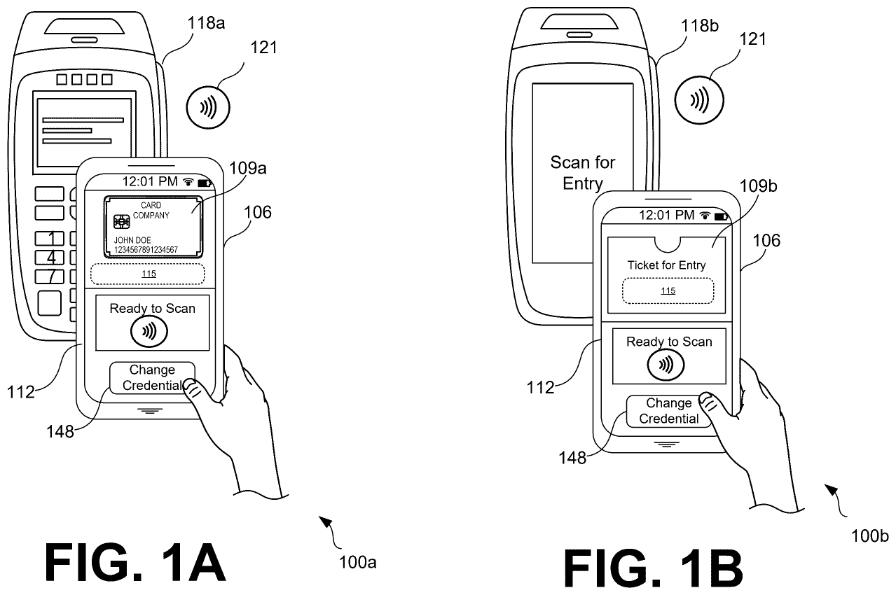

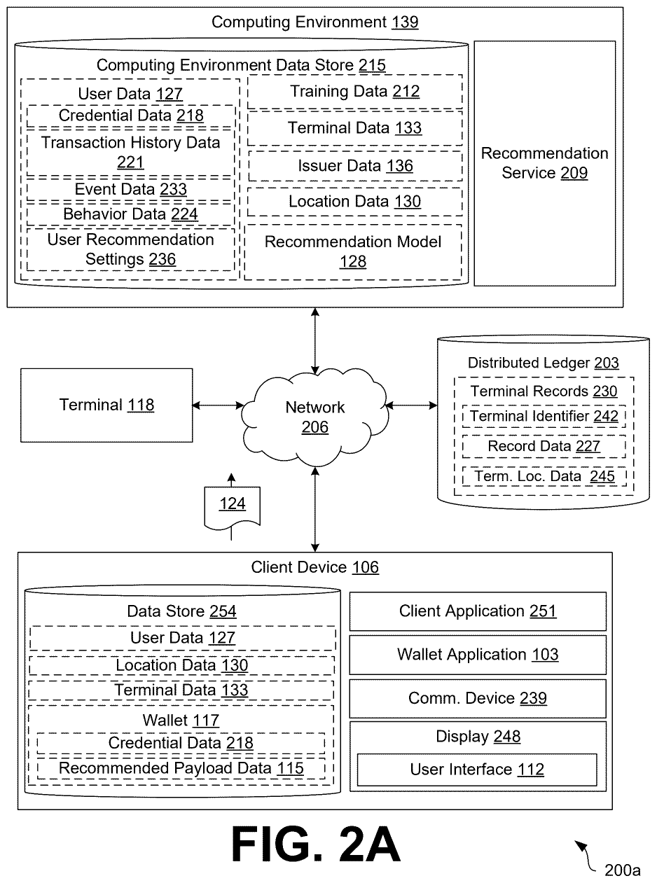

As illustrated in FIGS. 1A and 1B, shown are two example scenarios 100 (e.g., 100a and 100b) in which a wallet application 103 (FIGS. 2A and 2B) executing on a client device 106 presents a visual representation of a user credential 109 (e.g., 109a and 109b) in a user interface 112. According to various examples, the user credential 109 corresponds to a recommended credential 109 whose recommended payload data 115 has be generated and preloaded in a digital wallet 117 (FIGS. 2A and 2B) of the client device 106 in anticipation of a transfer to a terminal 118 (e.g., 118a and 118b). Accordingly, once authenticated, the user can tap or otherwise place the client device 106 in an appropriate proximity to the terminal 118 to establish a direct wireless connection 121 with the terminal 118 to transfer the recommended payload data 115 from the client device 106 to the terminal 118. In various examples, the terminal 118 can comprise a payment terminal, a point of sale (PoS) terminal, an access terminal, and/or other type of terminal that accepts direct wireless communications (e.g., NFC, Bluetooth, etc.) for communicating with a client device 106.

Scenario 100a corresponds to a user presenting a recommended credential 109a associated with a payment instrument to a payment terminal 118a for a payment transaction. For example, a user may be shopping at a particular retail store where the user can initiate the payment transaction with the payment terminal 118a associated with the retail store. Scenario 100b corresponds to a user presenting a recommended credential 109b associated with an event ticket to an access terminal 118 for entry into an event. For example, the user may be attending a concert where the event ticket is required for entry into the concert and the access terminal 118 is used to accept the event ticket for access.

In both scenarios 100, the wallet application 103 monitoring the device 106 and user interactions can detect a trigger event that can initiate the process for recommending a credential 109. A trigger event can be based at least in part on a time, a location, prior behavior, user defined settings, transaction data, an opening of a wallet application, terminal data, and/or other types of data. In some examples, the trigger event is detected based at least in part on an analysis of real-time user and device data using predication algorithms and/or prediction models. In other examples, the trigger event can be detected in response to the occurrence of a given action, time, and/or date. With respect to scenario 100a, the trigger event can correspond to user entering the store. In another example, the trigger event can correspond to the user visiting a first store, and based on past user behavior, the likelihood of the user entering the current store meets a threshold value that causes the trigger event to occur. In another example, with respect to scenario 100b, the trigger event can correspond to the user being within a predefined distance to an access terminal 118b associated with the event or the date or time being within a predetermined amount of time prior to the start of the event.

Context data 124 (FIG. 2A) associated with the user and client device 106 can be analyzed by a trained recommendation model 128 (FIGS. 2A and 2B) to recommend the credential 109 according to the context 124. The context data 124 can include user data 127 (FIGS. 2A and 2B), location data 130 (FIGS. 2A and 2B), terminal data 133 (FIGS. 2A and 2B), issuer data 136 (FIGS. 2A and 2B), and/or other types of data that can be used to discern a context for a given situation. The user data 127 can represent data associated with the user and the user's behavior. For example, the user data 127 can identify user credentials 109, user behavior, transaction history, user preferences, loyalty engagement data, event data, credential benefit data, and/or other types of data. The location data 130 can include a geolocation associated with the client device 106. The terminal data 133 can include data related to one or more terminals 118 in the given location including, for example, a terminal status, a terminal configuration, terminal payment criteria, and/or other data. The issuer data 136 can include data about the issuer associated with issuing one or more of the credentials 109 of the user. In the example of scenario 100a, the context data 124 could include card benefit data that indicates a card benefit for a given credential 109 that would be beneficial to the user if the user used the credential 109 corresponding to the card with the card benefit at the payment terminal 118a.

In various examples, the trained recommendation model 128 can be executed within the client device 106, as discussed with respect to FIG. 2B. In this example, the wallet application 103 can generate input data associated with the context data 124 and can apply the input data to the trained recommendation model 128. In other examples, as discussed with respect to FIG. 2A, the wallet application 103 can transmit the context data 124 to a computing environment 139 (FIG. 2A), and a recommendation service 142 (FIG. 2A) executing in the computing environment 139 can generate input data using the context data 124 and can apply the input data to the trained recommendation model 128. The output of the trained recommendation model 128 can include one or more recommended credentials 109 that should be preloaded in the user's wallet 117 for a future use.

According to various examples, the wallet application 103 can generate recommended payload data 115 associated with the recommended credential 109 and store the recommended payload data 115 in the user's wallet 117 stored on the client device 106. In some examples, the recommended payload data 115 can be generated to be compliant with transfer standards of the direct wireless connection 121. For example, if the direct wireless connection 121 is a near-field communication (NFC) connection, the recommended payload data 115 can an ISO7816 compliant and/or other NFC compliant tag that is generated to represent the credential 109 to be transferred. In some examples, recommended payload data 115 can be time bound such that they include an expiration date for how long they are to be preloaded in a user's wallet 117. For example, if a recommended credential 109 corresponds to a payment credential 109a, the recommended payload data 115 associated with the payment credential 109a can be generated to be valid for a predetermined amount of time.

In various examples, the wallet application 103 can generate a user interface 112 that can be rendered by the client device 106 for user interaction. In various examples, the user interface 112 can include a visual representation of the recommended credential 109 so that when the user approaches the terminal 118, the user can view what recommended credential 109 is preloaded into the wallet 117 so that the user does not have to search through his or her wallet 117 to identify or otherwise select a desired credential 109 to present at a terminal 118. As shown in FIGS. 1A and 1B, the user interface 112 can be generated to further include a change credential component 148. Upon selection of the change credential component 148, a user can override the use of the recommended credential 109 and select another credential 109 from his or her wallet 117.

With reference to FIG. 2A, shown is a network environment 200a according to various embodiments. The network environment 200a can include a computing environment 139, a client device 106, a terminal 118, and a distributed ledger 203, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 139 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 139 can employ a plurality of computing devices that can be arranged in one or more server banks or computer banks or other arrangements. Such computing devices can be located in a single installation or can be distributed among many different geographical locations. For example, the computing environment 139 can include a plurality of computing devices that together can include a hosted computing resource, a grid computing resource or any other distributed computing arrangement. In some cases, the computing environment 139 can correspond to an elastic computing resource where the allotted capacity of processing, network, storage, or other computing-related resources can vary over time.

Various applications or other functionality can be executed in the computing environment 139. The components executed on the computing environment 139 include a recommendation service 209, and other applications, services, processes, systems, engines, or functionality not discussed in detail herein.

The recommendation service 209 can be executed to train and execute a recommendation model 128 for recommending a credential 109 to use for a given context. In various examples, the recommendation service 209 can train a recommendation model 128 using training data 212 based on historical context data 124 to generate recommendations for credentials 109 to use for a given context. The training data 212 can include historical transaction data, historical user behavior data, historical location data, historical user settings, historical event of calendar data, historical card benefit data, historical terminal status data, historical merchant data, historical credential data and/or other types of data that can be used to infer a context and recommend a credential 109 for the given context.

In addition, the recommendation service 209 can be executed to obtain context data 124 from a client device 106 and provide a recommended credential 109 to the client device 106 in response to analyzing the context data 124 and/or other data. In various examples, the context data 124 can include user data 127, terminal data 133, issuer data 136, location data 130, and/or other types of data that can be used to discern a context for a given situation. The user data 127 can represent data associated with the user. For example, the user data 127 can identify user credentials 109, user behavior, transaction history, user preferences, loyalty engagement data, event data, credential benefit data, and/or other types of data associated with the user. The location data 130 can include a geolocation associated with the client device 106. The terminal data 133 can include data related to one or more terminals 118 in the given location including, for example, a terminal status, a terminal configuration, terminal payment criteria, and/or other data. The issuer data 136 can include data about the issuer who issued one or more of the credentials 109 to the user. In some examples, the issuer data 136 can include card benefit data that indicates a card benefit for a given credential 109 that would be beneficial to the user if the user used the credential 109 corresponding to the card with the card benefit at the terminal 118.

In some examples, the context data 124 received from the client device 106 includes a portion of the data discussed above, and the recommendation service 209 can obtain the remaining portions of the data from the computing environment data store 215, the distributed ledger 203, the terminal 118, and/or other system. For example, the computing environment 139 can be associated with an issuer of a payment card. In this example, the computing environment data store 215 can include user data 127 such as, for example, credential data 218, transaction history data 221, behavior data 224, and/or other data associated with credentials 109 issued to the user by the issuer of the computing environment 215.

In some examples, the recommendation service 209 can obtain terminal data 133 associated with terminals 118 located within a predefined vicinity of the geolocation of the client device 106 obtained from the location data 130. In this example, the recommendation service 209 can query the distributed ledger 203 using the geolocation, a terminal identifier 242, and/or other data to obtain terminal records 230 associated with one or more terminals 118. In particular, the terminal data 133 can include terminal status, terminal type, terminal manufacturer, terminal history, terminal location, and/or other data associated with a terminal 118. In other examples, the recommendation service 209 can obtain terminal data 133 from terminals 118, client devices 106, and/or other systems. In some examples, the terminal data 133 can be in the form of a discrete immutable asset (e.g., a non-fungible token (NFT)), a verifiable credential, and/or other type of secure record that can store data about a given terminal 118.

Using the context data 124 obtained from the client device 106, distributed ledger 203, computing environment data store 215, and/or other system, the recommendation service 209 can generate input data based at least in part on the context data 124 to apply to a trained recommendation model 128. Upon generating the input data, the recommendation service 209 can execute the recommendation model 128 and apply the input data to the recommendation model 128. The recommendation model 128 can be trained to infer a given context for the user and recommend one or more credentials 109 based at least in part on the context. The output of the recommendation model 128 can include the identification of one or more credentials 109. Upon obtaining the output from the recommendation model 128 the recommendation service 209 can send the one or more credentials 109, identification of the one or more credentials 109, credential data 218 associated with the one or more credentials, and/or other type of data associated with the recommended credentials 109 to the client device 106.

Also, various data is stored in a computing environment data store 215 that is accessible to the computing environment 139. The computing environment data store 215 can be representative of a plurality of computing environment data store 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the computing environment data store 215 is associated with the operation of the various applications or functional entities described below. This data can include user data 127, training data 212, terminal data 133, issuer data 136, location data 130, the recommendation model 128, and potentially other data.

The user data 127 can represent data associated with the user. For example, the user data 127 can include credential data 218, transaction history data 221, event data 233, behavior data 224, user recommendation settings 236, and/or other data associated with the user. The credential data 218 can include data associated with credentials 109 issued to the user. For example, the credential data 218 can comprise data identifying payment credentials, identification credentials, access credentials, loyalty account credentials, and/or other type of data associated with a credential 109 of a user.

A payment credential 109 can comprise data describing credit cards, debit cards, virtual cards, charge cards, and/or other mechanisms for effecting a payment with respect to a transaction account provided by the issuer and associated with the user of the client device 106. For example, for a credit card or a charge card, the payment credential 109 can store a card number, a cardholder name, an expiration date, a verification code, a billing address, and/or other information needed to consummate a payment. An identification credential 109 can be used to verify personal information about a user such as, for example, a user name, date of birth, address, photograph, identification number, biometric data, physical characteristics, and/or other type of personal information. An access credential 109 can be used to grant the user access to a specific location. The access credential can comprise user information, access level, credential type, issuing authority, expiration data, and/or other types of information.

The transaction history data 221 includes transaction data associated with prior transactions associated with any one of the user credentials 109 represented by the credential data 218. In the example of a payment transaction, the transaction history data 221 can include a transaction amount, a transaction merchant, industry identification data associated with the transaction, transaction time, transaction date, transaction authentication mode, transaction mode, transaction location information, network connectivity data, device data, user account data, and/or other attributes associated with a given transaction.

The event data 233 can represent data corresponding to events associated with the user. For example, the event data 233 can include calendar data, ticket data, registration data, and/or other type of information associated with an event. The event data 233 can include a type of event, a date of the event, a location of the event, and/or other type of event information.

The behavior data 224 can represent data associated with the user's behavior. For example, the behavior data 224 can include digital interactions (e.g., page views, scrolling behavior, search queries, digital purchase behavior, etc.), routine physical behaviors (e.g., where a user routinely visits), transaction behaviors (e.g., what payment card a user uses at a given store, transaction terminal mode (e.g., tap, insert, swipe, use wallet 117, etc.), loyalty engagement data, and/or other type of data that can define a user's actions in a given situation.

The user recommendation settings 236 can represent user-defined data with respect to credential preferences. In one example, a user can define whether they like or don't like to use a certain payment credential 109 when traveling. In another example, the user can state that when presenting an identification credential 109 for age verification, they do not want their age shown but rather that they are above or below a certain age. The user recommendation settings 236 can be useful to the recommendation model 128 in understanding the user preferences for credential selection and recommendation.

The training data 212 can represent data that can be used by the recommendation service 209 to train a recommendation model. For example, the training data 212 can include historical transaction data, historical user behavior data, historical location data, historical user settings, historical event of calendar data, historical card benefit data, historical terminal status data, historical merchant data, historical credential data and/or other types of data that can be used to infer a context and recommend a credential 109 for the given context. The training data 212 can include user specific data and/or aggregate user data. In some example, the training data 212 can include feedback data that can be used to update and/or retrain the recommendation model 128. The feedback data can be obtained in response to a user interacting with a wallet application 103 on his or her client device 106. For example, if the user interface 112 includes a recommended credential 109 that is not what the user would like to use, the user can be redirected to a feedback user interface 112 that allows the user to update or otherwise provide feedback as to why the recommended credential 109 was not used by the user.

The terminal data 133 can include data related to one or more terminals 118 in the given location including, for example, a terminal status, a terminal configuration, terminal payment criteria, and/or other data. For example, the terminal data 133 can be used to indicate whether a given terminal 118 is working or not working. In another example, the terminal data 133 can be used to indicate what type of payment credentials 109 are accepted by the terminal 118. In various examples, terminal data 133 can be obtained by querying a distributed ledger 203 that includes terminal records 230 that include terminal metadata associated with a given terminal. In other examples, the terminal data 133 can be represented by one or more verifiable credentials that can be generated and obtained by a user device 106, an issuer, a terminal 118, and/or other system that may be interacting with a terminal 118.

The issuer data 136 can include data about the issuer who issued one or more of the credentials 109 to the user. For example, the issuer data 136 can include credential benefit data, loyalty engagement data, issuer contact information, issuer type, security preferences, and/or other data associated with the user. In some examples, the issuer data 136 can include card benefit data that indicates a card benefit for a given credential 109 that would be beneficial to the user if the user used the credential 109 corresponding to the card with the card benefit at the terminal 118. This information can be used by the recommendation model 128 to choose a credential 109 that the user might not otherwise chose due to the user not having the knowledge of the card benefit at the time of a given transaction.

The location data 130 can include geolocation data associated with a location of the client device 106. For example, the location data 130 can include geographic coordinates, street address, timestamp data associated with when the location is recorded, and/or other type of data that can be used to approximate a location of the client device 106.

The recommendation model 128 can include, for example, a logistic regression classifier, a random forest classifier, a decision tree classifier, a XGBoost classifier, a multi-layer perceptron classifier, a recurrent neural network, a feed-forward neural network, a label-specific attention network, and/or any other type of trained model as can be appreciated. According to various examples, the recommendation model can be trained using training data 212 to analyze input data (e.g., user interaction data, loyalty engagement data, user data, geolocation, event or calendar data, card benefits, terminal data, credential data, terminal data, issuer data, etc.) to make an informed hypothesis of what context may be sought by a terminal (e.g., payment, loyalty account creation, event ticket presentment, identity authentication, etc.) and what credential should be presented at the terminal.

The terminal 118 can represent a transaction system that can include a corresponding computer system or computing device with a processor and a memory. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a payment terminal, an access terminal, a point of sale (PoS) system, or other devices with like capability.

In various examples, the terminal 118 can accept direct wireless communications (e.g., NFC, Bluetooth, etc.) for communicating with a client device 106. For example, when a user is wanting to access to a given location, the user could tap or otherwise place the client device 106 and/or communication device 239 of the client device 106 in an appropriate proximity to the terminal 118 to establish a direct wireless connection 121 with the terminal 133. Upon establishing a direct wireless connection 121, the client device 106 can transmit recommended payload data 115 associated with a credential 109 to the terminal 118.

The distributed ledger 203 represents a public or semi-public synchronized, eventually consistent, data store spread across multiple nodes, some or all of which can be in different geographic or network locations. Records of transactions involving the distributed ledger 203 can be shared or replicated using a peer-to-peer network connecting the individual nodes that can write to the distributed ledger 203. Once a transaction or record is recorded in the distributed ledger 203, it can be replicated across the peer-to-peer network until the record is eventually recorded with all of the nodes. Various consensus methods can be used to ensure that data is written reliably to the distributed ledger 203. Examples of a distributed ledger can include blockchains, distributed hash tables (DHTs), and similar data structures.

Various data can also be stored in a distributed ledger 203. This can include one or more terminal records 230 and/or other information. However, any other data discussed in the present disclosure could also be stored in the distributed ledger 203 if the public availability of the data were acceptable in that particular implementation.

The terminal records 230 can represent records associated with terminal 118 that can be used to generate terminal data 133. The terminal records 230 can include a terminal identifier 242, record data 227, terminal location data 245, and/or other type data associated with a terminal 118. The terminal identifier 242 can include a unique identifier that is associated with a given terminal 118. The record data 227 includes data that describes characteristics of the terminal 118. For example, the record data 227 can include a terminal status, a terminal configuration, terminal payment criteria, and/or other data. In some examples, the record data 227 includes a location status, a transaction status, a number of transaction attempts, terminal uptime, terminal downtime, provider of terminal 118, merchant associated with the terminal 118, software version of the terminal 118, and/or other data. The terminal location data 245 can include location data associated with the terminal 118. For example, the terminal location data 245 can include a geolocation, a location within a premise (e.g., back of store, front of store, venue gate number, etc.).

In various examples, a terminal record 230 or the record data 227 can correspond to a discrete immutable asset (e.g., non-fungible token (NFT)) that can be created and stored on the distributed ledger 203 to represent an interaction with a given terminal 118. For example, when a client device 106 interacts with a terminal 118, the client device 106 can generate and write a terminal record 230 to the distributed ledger 203 describing the experience of the interaction with respect to the given terminal 118. In other examples, the terminal 118 can generate and write terminal records 230 to the distributed ledger 203 based at least in part on an interaction with a client device 106 or a payment card. In some examples, an issuer device can generate and write terminal records 230 to the distributed ledger 203 based at least in part on an interaction with a client device 106 or a payment card issued by the issuer.

The client device 106 is representative of a plurality of client devices that can be coupled to the network 206. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 248, such as liquid crystal displays (LCDs), gas plasma-based flat panel displays, organic light emitting diode (OLED) displays, electrophoretic ink (“E-ink”) displays, projectors, or other types of display devices. In some instances, the display 248 can be a component of the client device 106 or can be connected to the client device 106 through a wired or wireless connection.

The client device 106 can be configured to execute various applications such as a client application 251, a wallet application 103, or other applications. The client application 251 can be executed by a client device 106 to access network content served up by the computing environment 139 or other servers, thereby rendering a user interface 112 on the display 248. To this end, the client application 251 can include a browser, a dedicated application, or other executable, and the user interface 112 can include a network page, an application screen, or other user mechanism for obtaining user input. The client device 106 can be configured to execute applications beyond the client application 251 such as email applications, social networking applications, word processors, spreadsheets, or other applications.

The wallet application 103 can be executed to monitor the client device 106 and user interactions with the client device 106. For example, the wallet application 103 can monitor location data 130 associated with the location of the client device 106, user data 127 including transaction history data 221, event data 233, and behavior data 224, user recommendation settings 236, and/or other data that can be monitored by the wallet application 103 to allow the wallet application 103 to detect a trigger event.

In various examples, the wallet application 103 monitoring the client device 106 and user interactions can detect a trigger event that can initiate the process for recommending a credential 109. A trigger event can be based at least in part on one or more factors including, a time, a location, prior behavior, user defined settings, transaction data, an opening of a wallet application, terminal data, and/or other types of data. In some examples, the wallet application 103 can analyze the factors using one or more prediction algorithms or trained prediction models to detect a trigger event. In other examples, the wallet application 103 can detect the trigger event in response to the occurrence of a given action, time, and/or date. For example, the wallet application 103 can detect a trigger event associated with a user entering the store based at least in part on location data 130. In another example, the trigger event can correspond to the user visiting a first store, and based on user behavior 224, the likelihood of the user entering the current store meets a threshold value that causes the trigger event to occur. In another example, the wallet application 103 can detect a trigger event can correspond to the user being within a predefined distance to an access terminal 118 associated with the event or the date or time being within a predetermined amount of time prior to the start of the event.

The wallet application 103 can further generate context data 124 associated with the user and client device. The context data 124 can include user data 127, location data 130, terminal data 133, issuer data 136, and/or other types of data that can be used to discern a context for a given situation. In response to detecting a trigger event, the wallet application 103 can transmit the context data 124 to the recommendation service 209. For example, the wallet application 103 can transmit the context data 124 to the recommendation service 209 with a request for a credential recommendation.

The wallet application 103 can receive a credential recommendation from the recommendation service 209. The credential recommendation can comprise an output of a recommendation model 128 executed by the recommendation service 209. The wallet application 103 can generate recommended payload data 115 associated with the recommended credential 109 and store the recommended payload data 115 in the user's corresponding wallet 117 stored on the client device 106. In some examples, the recommended payload data 115 can be generated to be compliant with transfer standards of the direct wireless connection 121. For example, if the direct wireless connection 121 is a near-field communication (NFC) connection, the recommended payload data 115 can an ISO7816 compliant and/or other NFC compliant tag that is generated to represent the credential 109 to be transferred. In some examples, recommended payload data 115 can be time bound such that they include an expiration date for how long they are to be preloaded in a user's wallet 117. For example, if a recommended credential 109 corresponds to a payment credential 109, the recommended payload data 115 associated with the payment credential 109 can be generated to be valid for a predetermined amount of time.

In various examples, the wallet application 103 can generate a user interface 112 can be rendered by the client device 106 for user interaction. In various examples, the user interface 112 can include a visual representation of the recommended credential 109 so that when the user approaches the terminal 118, the user can view what recommended credential 109 is preloaded into the wallet 117 so that the user does not have to search through his or her wallet 117 to identify or otherwise select a desired credential 109 to present at a terminal 118. The wallet application 103 can generate the user interface 112 to include a change credential component 148. Upon selection of the change credential component 148, a user can override the use of the recommended credential 109 and select another credential 109 from his or her wallet 117. In some examples, the user can provide feedback which the wallet application 103 can transmit to the recommendation service 209. The recommendation service 209 can then use the feedback data to retrain the recommendation model 128.

In some examples, the wallet application 103 can authenticate a user prior to allow the recommended payload data 115 to be transferred to a terminal 118. In various examples, the wallet application 103 can require the user to provide a passcode, biometric, and/or other authentication means prior to transmitting the recommended payload data 115 to a terminal. For example, the wallet application 103 can generate and render a pop-up box or other type of user interface component requesting the user enter a particular passcode or provide a biometric. Upon authenticating the user, the wallet application 103 can permit the communication device 239 to transmit the recommended payload data 115 to the terminal 118.

In some examples, the wallet application 103 or other application on the client device 106 can generate record data 227 associated with a given terminal 118 in response to an interaction with the terminal 118. The record data 227 includes data that describes characteristics of the terminal 118. For example, the record data 227 can include a terminal status, a terminal configuration, terminal payment criteria, and/or other data. In some examples, the record data includes a location status, a transaction status, a number of transaction attempts, terminal uptime, terminal downtime, provider of terminal 118, merchant associated with the terminal 118, software version of the terminal 118, and/or other data. In some examples, the record data 227 is in the form of a discrete immutable asset (e.g., NFT) that is written to the distributed ledger 203 in association with a given terminal 118 or corresponding terminal record. In other examples, the record data 227 can comprise a verifiable credential.

Also, various data is stored in the client data store 254 that is accessible to the client device 106. The client data store 254 can be representative of a plurality of data stores as can be appreciated. The data stored in the client data store 254, for example, is associated with the operation of various applications and/or functional entities described herein. The client data store 254 can store user data 127, location data 130, terminal data 133, a wallet 117, and other data as can be appreciated.

The user data 127 can represent data associated with the user. For example, the user data 127 can include credential data 218, transaction history data 221, event data 233, behavior data 224, user recommendation settings 236, and/or other data associated with the user. The location data 130 can include a geolocation associated with the client device 106.

The location data 130 can include geolocation data associated with a location of the client device 106. For example, the location data 130 can include geographic coordinates, street address, timestamp data associated with when the location is recorded, and/or other type of data that can be used to approximate a location of the client device 106. The terminal data 133 can include data related to one or more terminals 118 in the given location including, for example, a terminal status, a terminal configuration, terminal payment criteria, and/or other data. In various examples, the wallet application 103 can query the distributed ledger 203, an issuer device, or the terminal 118 to obtain record data 127 associated with a given terminal 133.

The wallet 117 is associated with the wallet application 103 and corresponds to a digital credential wallet for securely storing credentials 109 and associated credential data 218 of the user. In addition, the wallet 117 can be preloaded with recommended payload data 115 based at least in part on a recommended credential 109. The recommended payload data 115 can comprise a pre-generated payload corresponding to a credential 109 that is identified as being likely to be used for an upcoming transaction based at least in part on an analysis of the user and device context. The recommended payload data 115 can include a credential identifier, credential data 218, credential security features (e.g., public key), a digital signature, an expiration date, and/or other type of data that would be needed by a receiving terminal 118 to complete a transaction.

In various examples, the client device 106 can include a communication device 239 which can either be integrated within the client device 106 and/or in data communication with the client device 106. The communication device 239 can include a device that uses protocol standards to establish a direct wireless connection 121 with other devices with similar or like capability. For example, the communication device 239 can comprise an NFC device that uses NFC protocols to establish NFC peer-to-peer connections for exchanging data wirelessly via an NFC protocol to another devices with similar or like capability. For example, the wallet application 103 can interact with the communication device 239 to transfer recommended payload data 115 to a terminal 118 in response to the communication device 239 establishing a direct wireless connection 121 with the terminal 118.

Moving on to FIG. 2B, shown is a network environment 200b according to various embodiments. The network environment 200b can include a computing environment 139, a client device 106, a terminal 118, and a distributed ledger 203, which can be in data communication with each other via a network 206. The network environment 200b differs from the network environment 200a of FIG. 2A in that the recommendation model 128 trained by the recommendation service 209 can be transmitted or otherwise pushed to the client device 106 for execution by the client device 106 instead of being executed by the recommendation service 209. In this example, rather than transmitting generated context data 124 to the recommendation service 209 with a request for a recommended credential 109, the wallet application 103 executing on the client device 106 can generate input data based on the context data 124, execute the trained recommendation model 128 locally, and apply the input data to the trained recommendation model 128. In this example, the recommendation service 209 can train and retrain the recommendation model 128 and then transmit the recommendation model 128 to the client device 106.

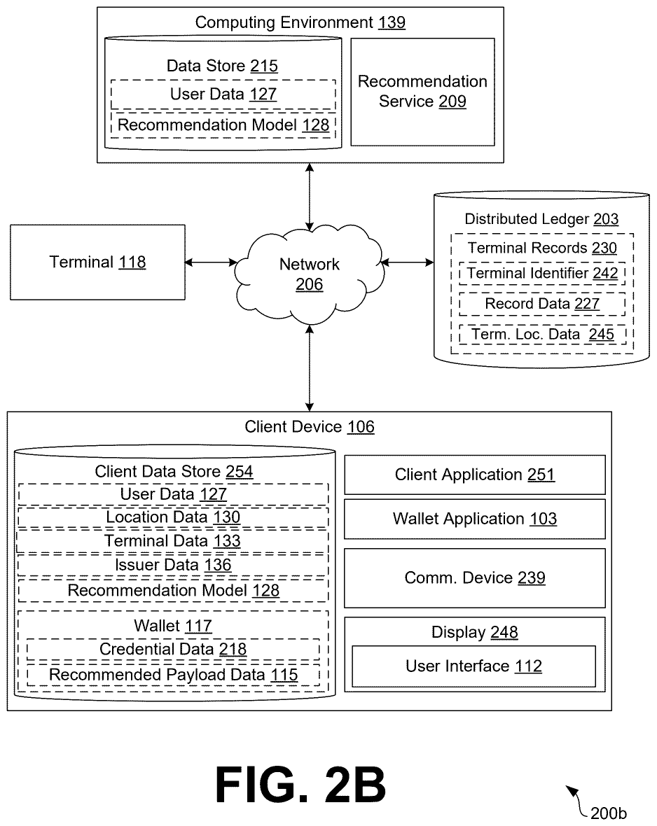

Referring next to FIG. 3, shown is a sequence diagram 300 depicting the interactions between the various components of the network environment 200a according to various embodiments of the present disclosure. The sequence diagram of FIG. 3 is intended to illustrate how a credential 109 can be recommended for a given context. As an alternative, the sequence diagram 300 of FIG. 3 can be viewed as depicting an example of elements of a method implemented within the network environment 200a.

Beginning with block 303, the wallet application 103 can detect a trigger event. For example, the wallet application 103 can monitor location data 130 associated with the location of the client device 106, user data 127 including transaction history data 221, event data 233, and behavior data 224, user recommendation settings 236, and/or other data that can be monitored by the wallet application 103 to allow the wallet application 103 to detect a trigger event. A trigger event can be based at least in part on one or more factors including, a time, a location, prior behavior, user defined settings, transaction data, an opening of a wallet application, terminal data, and/or other types of data. In some examples, the wallet application 103 can analyze the factors using one or more prediction algorithms or trained prediction models to detect a trigger event. In other examples, the wallet application 103 can detect the trigger event in response to the occurrence of a given action, time, and/or date. For example, the wallet application 103 can detect a trigger event associated with a user entering the store based at least in part on location data 130. In another example, the trigger event can correspond to the user visiting a first store, and based on user behavior 224, the likelihood of the user entering the current store meets a threshold value that causes the trigger event to occur. In another example, the wallet application 103 can detect a trigger event can correspond to the user being within a predefined distance to an access terminal 118 associated with the event or the date or time being within a predetermined amount of time prior to the start of the event.

At block 306, the wallet application 103 can collect context data 124 and provided the context data 124 to the recommendation service 209. For example, the wallet application 103 can generate context data 124 associated with the user and client device. The context data 124 can include user data 127, location data 130, terminal data 133, issuer data 136, and/or other types of data that can be used to discern a context for a given situation. In response to detecting a trigger event, the wallet application 103 can transmit the context data 124 over the network 206 to the recommendation service 209. For example, the wallet application 103 can transmit the context data 124 to the recommendation service 209 with a request for a credential recommendation.

At block 309, the recommendation service 209 can generate input data to apply to a recommendation model 128 based at least in part on context data 124. In some examples, the context data 124 received from the client device 106 includes a portion of the data needed to generate the input data. For example, the context data 124 received from the client device 106 may only include user data 127 and location data 130. In some examples, the recommendation service 209 can obtain the remaining portions of the data (e.g., terminal data 133, issuer data 136, etc.) from the computing environment data store 215, the distributed ledger 203, the terminal 118, and/or other system.

In some examples, the recommendation service 209 can obtain terminal data 133 associated with terminals 118 located within a predefined vicinity of the geolocation of the client device 106 obtained from the location data 130. In this example, the recommendation service 209 can query the distributed ledger 203 using the geolocation, a terminal identifier 242, and/or other data to obtain terminal records 230 associated with one or more terminals 118. In particular, the terminal data 133 can relate to terminal records 230 stored in the distributed ledger 203 and can include terminal status, terminal type, terminal manufacturer, terminal history, terminal location, and/or other data associated with a terminal 118. In other examples, the recommendation service 209 can obtain terminal data 133 from terminals 118, client devices 106, and/or other systems. In some examples, the terminal data 133 can be in the form of a discrete immutable asset (e.g., non-fungible token (NFT)), a verifiable credential, and/or other type of secure record that can store data about a given terminal 118.

Using the context data 124 obtained from the client device 106, distributed ledger 203, computing environment data store 215, and/or other system, the recommendation service 209 can generate input data based at least in part on the context data 124 to apply to a trained recommendation model 128. The input data can be generated to comply with configurations required by the recommendation model 128.

At block 312, the recommendation service 209 can apply the input data to the recommendation model 128. For example, the recommendation service 209 can execute the recommendation model 128 and apply the input data to the recommendation model 128. The recommendation model 128 can be trained to infer a given context for the user based at least in part on the input data and recommend one or more credentials 109 based at least in part on the context.

At block 315, the recommendation service 209 can identify a recommended credential 109. For example, the recommendation service 209 can obtain an output of the recommendation model 128 and identify the recommendation credential 109 based at least in part on the output of the recommendation model 128. In some examples, the output is the identification of the recommendation credential 109. In other examples, the output can contain information that identifies the recommendation credential 109 such as for example, a credential identifier, a credential name, a credential type, and/or other data. In some examples, the output can include a reasoning for the selection of the recommended credential 109. For example, if the credential 109 is selected because of a benefit offer, the reasoning can identify the benefit offer.

At block 318, the recommendation service 209 can send the recommended credential 109 to the client device 106. For example, the recommendation service 209 can send data identifying the recommendation credential 109 to the wallet application 103. In another example, the recommendation service 209 can send credential data 218 associated with the recommended credential 109 to the wallet application 103 of the client device 106.

At block 312, the wallet application 103 can generate recommended payload data 115 based on the recommended credential 109. The recommended payload data 115 can comprise a pre-generated payload corresponding to a credential 109 that is identified as being likely to be used for an upcoming transaction based at least in part on an analysis of the user and device context. The recommended payload data 115 can include a credential identifier, credential data 218, credential security features (e.g., a public encryption key), a digital signature, an expiration date, and/or other type of data that would be needed by a receiving terminal 118 to complete a transaction. In some examples, the recommended payload data 115 can be generated to be compliant with transfer standards of the direct wireless connection 121. For example, if the direct wireless connection 121 is a near-field communication (NFC) connection, the recommended payload data 115 can an ISO7816 compliant and/or other NFC compliant tag that is generated to represent the credential 109 to be transferred.

At block 315, the wallet application 103 via the communication device 239 can transfer the recommended payload data 115 to the terminal 118. For example, when a user wants to present the credential 109 to a terminal 118, the user can tap or otherwise place the client device 106 in an appropriate proximity to the terminal 118 to establish a direct wireless connection 121 with the terminal 118 to transfer the recommended payload data 115 from the client device 106 to the terminal 118. In some examples, the wallet application 103 can authenticate the user prior to allowing the recommended payload data 115 to be transferred to the terminal 118. In various examples, the wallet application 103 can require the user to provide a passcode, biometric, and/or other authentication means prior to transmitting the recommended payload data 115 to a terminal. For example, the wallet application 103 can generate and render a pop-up box or other type of user interface component requesting the user enter a particular passcode or provide a biometric. Upon authenticating the user, the wallet application 103 can permit the communication device 239 to transmit the recommended payload data 115 to the terminal 118 via the direct wireless connection 121. Thereafter, this portion of the process proceeds to completion.

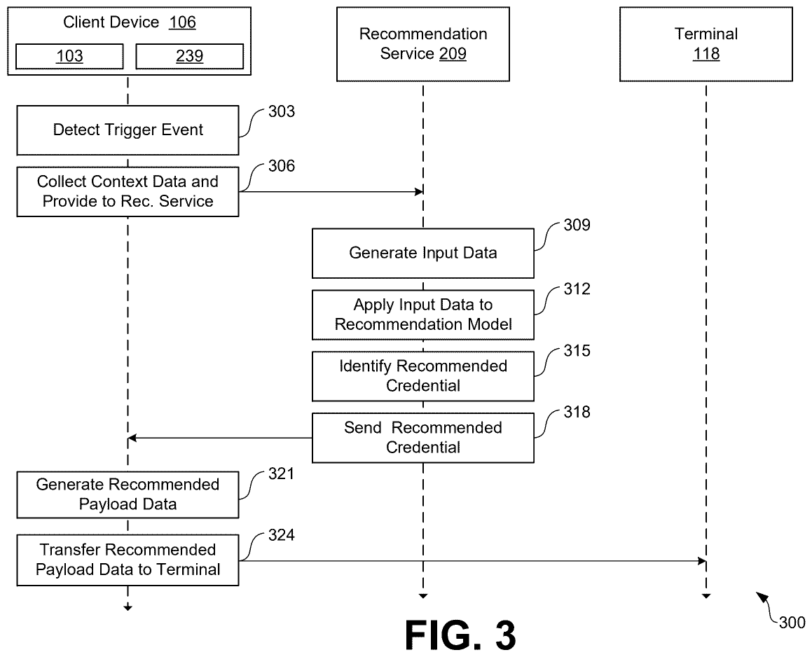

Referring next to FIG. 4, shown is a flowchart that provides one example of the operation of a portion of the wallet application 103. The flowchart of FIG. 4 provides merely an example of the many different types of functional arrangements that can be employed to implement the operation of the depicted portion of the wallet application 103. As an alternative, the flowchart of FIG. 103 can be viewed as depicting an example of elements of a method implemented within the network environment 200.

Beginning with block 403, the wallet application 103 can monitor the client device 106 and user interaction. For example, the wallet application 103 can monitor location data 130 associated with the location of the client device 106, user data 127 including transaction history data 221, event data 233, and behavior data 224, user recommendation settings 236, and/or other data that can be monitored by the wallet application 103.

At block 406, the wallet application 103 can determine if a trigger event has occurred. A trigger event can be based at least in part on one or more factors including, a time, a location, prior behavior, user defined settings, transaction data, an opening of a wallet application, terminal data, and/or other types of data. In some examples, the wallet application 103 can analyze the factors using one or more prediction algorithms or trained prediction models to detect a trigger event. In other examples, the wallet application 103 can detect the trigger event in response to the occurrence of a given action, time, and/or date. If a trigger event is not detected, the wallet application 103 returns to block 403. Otherwise, the wallet application 103 proceeds to block 409.

At block 409, the wallet application 103 can query a distributed ledger 203 for terminal data 133. In this example, the wallet application 103 can query the distributed ledger 203 using the location data 130, a terminal identifier 242, and/or other data to obtain terminal records 230 associated with one or more terminals 118. In particular, the terminal data 133 can relate to terminal records 230 stored in the distributed ledger 203 and can include terminal status, terminal type, terminal manufacturer, terminal history, terminal location, and/or other data associated with a terminal 118. In other examples, the wallet application 103 can obtain terminal data 133 from terminals 118, the computing environment 139, another client devices 106, and/or other systems. In some examples, the terminal data 133 can be in the form of a discrete immutable asset (e.g., non-fungible token (NFT)), a verifiable credential, and/or other type of secure record that can store data about a given terminal 118.

At block 412, the wallet application 103 can generate input data to apply to the recommendation model 128. For example, the wallet application 103 can generate context data 124 associated with the user and client device. The context data 124 can include user data 127, location data 130, terminal data 133, issuer data 136, and/or other types of data that can be used to discern a context for a given situation. The wallet application 103 can generate the input data based at least in part on the context data 124. The input data can be generated to comply with configurations required by the recommendation model 128.

At block 415, the wallet application 103 can apply the input data to the recommendation model 128. For example, the wallet application 103 can execute the recommendation model 128 and apply the input data to the recommendation model 128. The recommendation model 128 can be trained to infer a given context for the user based at least in part on the input data and recommend one or more credentials 109 based at least in part on the context.

At block 418, the wallet application 103 can identify a recommended credential 109. For example, the wallet application 103 can obtain an output of the recommendation model 128 and identify the recommendation credential 109 based at least in part on the output of the recommendation model 128. In some examples, the output is the identification of the recommendation credential 109. In other examples, the output can contain information that identifies the recommendation credential 109 such as for example, a credential identifier, a credential name, a credential type, and/or other data. In some examples, the output can include a reasoning for the selection of the recommended credential 109. For example, if the credential 109 is selected because of a benefit offer, the reasoning can identify the benefit offer.

At block 421, the wallet application 103 can generate recommended payload data 115 based on the recommended credential 109. The recommended payload data 115 can comprise a pre-generated payload corresponding to a credential 109 that is identified as being likely to be used for an upcoming transaction based at least in part on an analysis of the user and device context. The recommended payload data 115 can include a credential identifier, credential data 218, credential security features (e.g., public key), a digital signature, an expiration date, and/or other type of data that would be needed by a receiving terminal 118 to complete a transaction. In some examples, the recommended payload data 115 can be generated to be compliant with transfer standards of the direct wireless connection 121. For example, if the direct wireless connection 121 is a near-field communication (NFC) connection, the recommended payload data 115 can an ISO7816 compliant and/or other NFC compliant tag that is generated to represent the credential 109 to be transferred.

At block 424, the wallet application 103 can store the recommended payload data 115 in the corresponding wallet 117. For example, the recommended payload data 115 can be stored in the wallet 117 as a preemptive measure to preload the wallet 117 with the recommended payload data 115. Accordingly, the recommended payload data 115 is ready for transfer without the need for user selection of a given credential 109 prior to transferring to a terminal 118. Thereafter, this portion of the process proceeds to completion.

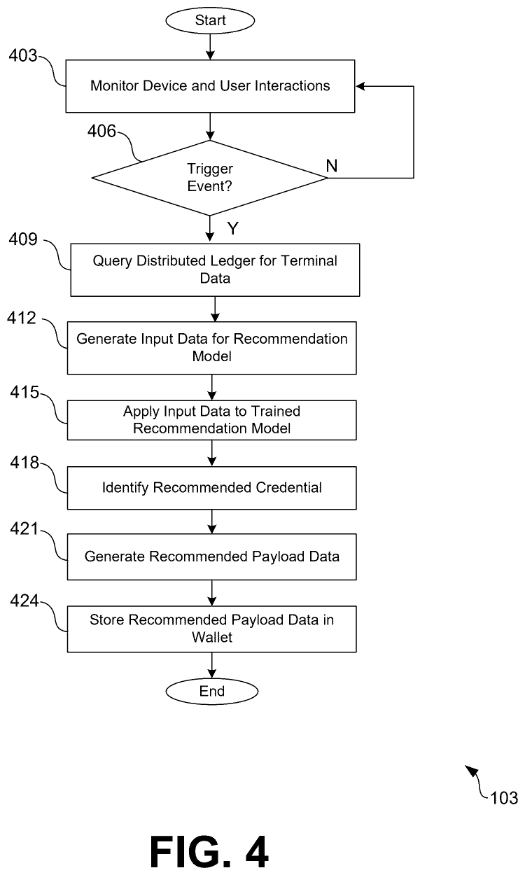

Referring next to FIG. 5, shown is a flowchart that provides one example of the operation of a portion of the wallet application 103 The flowchart of FIG. 5 provides merely an example of the many different types of functional arrangements that can be employed to implement the operation of the depicted portion of the wallet application 103. As an alternative, the flowchart of FIG. 5 can be viewed as depicting an example of elements of a method implemented within the network environment 200.

Beginning with block 503, the wallet application 103 can generate a user interface 112 including recommended payload data 115. In various examples, the user interface 112 can include a visual representation of the recommended credential 109 so that when the user approaches the terminal 118, the user can view what recommended credential 109 is preloaded into the wallet 117 so that the user does not have to search through his or her wallet 117 to identify or otherwise select a desired credential 109 to present at a terminal 118. The wallet application 103 can generate the user interface 112 to include a change credential component 148. Upon selection of the change credential component 148, a user can override the use of the recommended credential 109 and select another credential 109 from his or her wallet 117. In some examples, the user can provide feedback which the wallet application 103 can transmit to the recommendation service 209.

At block 506, the wallet application 103 can cause the user interface 112 to be rendered on a display 248 of the client device 106. For example, when a user requests to open the wallet application 103 on the client device 106, the wallet application 103 can cause the generated user interface 112 to be displayed on the display 248 to allow the user to interact with the wallet application 103 and to view the recommended credential 109.

At block 509, the wallet application 103 can determine if the recommended credential 109 needs to be updated. For example, if a user selects the change credential component 148 included in the user interface 112, the wallet application 103 can determine that the recommended credential needs to be updated. If the credential 109 needs to be updated, the wallet application 103 proceeds to block 512. Otherwise, the wallet application 103 proceeds to block 515.

At block 512, the wallet application 103 can generate payload data 115 for an updated credential. In this example, the recommended credential 109 is not what the user would like to present to the terminal 118. Therefore, the wallet application 103 can generate and render a user interface 112 that allows the user to select from a plurality of stored credentials 109 in his or her wallet 117. Upon selection of a given credential 109, the wallet application can generate the payload data 115 for the updated credential 109. In some examples, the payload data 115 can be generated to be compliant with transfer standards of the direct wireless connection 121. For example, if the direct wireless connection 121 is a near-field communication (NFC) connection, the payload data 115 can an ISO7816 compliant and/or other NFC compliant tag that is generated to represent the credential 109 to be transferred.

At block 515, the wallet application 103 can receive a request to transfer the credential 109 to a terminal 118. For example, when a user wants to present the credential 109 to a terminal 118, the user can tap or otherwise place the client device 106 in an appropriate proximity to the terminal 118 to establish a direct wireless connection 121 with the terminal 118 to transfer the recommended payload data 115 from the client device 106 to the terminal 118. The request to transfer the credential 109 to the terminal 118 can be in response to the direct wireless connection 121 being established. In other examples, the request can be received in response to an interaction with the user interface 112 and/or the client device 106.

At block 518, the wallet application 103 can determine if authentication of the user is required prior to transmitting the payload data 115 of the credential 109. For example, for payment transactions, authentication may only be required if the transaction amount meets or exceeds a given threshold value. In another example, the user recommendation settings 236 can define criteria regarding whether authentication is required prior to using a particular credential 109. If authentication is required, the proceeds to block 521. Otherwise, the process proceeds to block 524.

At block 521, the wallet application 103 can authenticate the user prior to allowing the recommended payload data 115 to be transferred to the terminal 118. In various examples, the wallet application 103 can require the user to provide a passcode, biometric, and/or other authentication means prior to transmitting the recommended payload data 115 to a terminal. For example, the wallet application 103 can generate and render a pop-up box or other type of user interface component requesting the user enter a particular passcode or provide a biometric.

At block 524, the wallet application 103 via the communication device 239 can transfer the recommended payload data 115 to the terminal 118. For example, the wallet application 103 can permit the communication device 239 to transmit the recommended payload data 115 (or updated payload data 115) to the terminal 118 via the direct wireless connection 121. Thereafter, this portion of the process proceeds to completion.

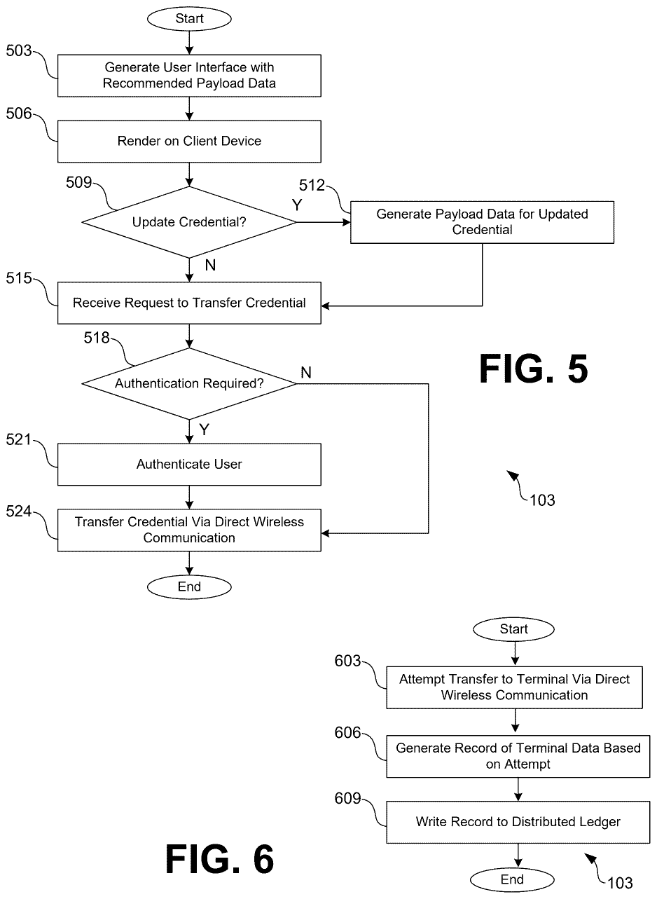

Referring next to FIG. 6, shown is a flowchart that provides one example of the operation of a portion of the wallet application 103. The flowchart of FIG. 6 provides merely an example of the many different types of functional arrangements that can be employed to implement the operation of the depicted portion of the wallet application 103. As an alternative, the flowchart of FIG. 6 can be viewed as depicting an example of elements of a method implemented within the network environment 200.

Beginning with block 603, the wallet application 103 via the communication device 239 can attempt to transfer payload data 115 to a terminal 118 via a direct wireless connection 121. For example, a user can tap or otherwise place the client device 106 in an appropriate proximity to the terminal 118 to attempt establish a direct wireless connection 121 with the terminal 118 to transfer the payload data 115 stored in a wallet 117 and accessible by the wallet application 103 from the client device 106 to the terminal 118. In some examples, the direct wireless connection 121 can be established. In other examples, the terminal 118 can be out of service or having connection difficulties, and the direct wireless connection 121 cannot be established or may require multiple attempts prior to establishing a connection.

At block 606, the wallet application 103 can generate a terminal record 230 for a given terminal 118 or record data 227 associated with a given terminal 118 that details the attempt with the terminal 118. The record data 227 includes data that describes characteristics of the terminal 118. For example, the record data 227 can include a terminal status, a terminal configuration, terminal payment criteria, and/or other data. In some examples, the record data includes a location status, a transaction status, a number of transaction attempts, terminal uptime, terminal downtime, provider of terminal 118, merchant associated with the terminal 118, software version of the terminal 118, and/or other data. In some examples, the record data 227 is in the form of a discrete immutable asset (e.g., NFT) that is written to the distributed ledger 203 in association with a given terminal 118 or corresponding terminal record. In other examples, the record data 227 can comprise a verifiable credential.

At block 609, the wallet application 103 can write the terminal record 230 and/or record data 227 associated with the terminal 118 to the distributed ledger 203. Once the terminal record 230 and/or record data 227 is recorded in the distributed ledger 203, it can be replicated across the peer-to-peer network until the record is eventually recorded with all of the nodes of the distributed ledger. Various consensus methods can be used to ensure that data is written reliably to the distributed ledger 203. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 139.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a client device comprising a processor and a memory; and
machine-readable instructions stored in the memory that, when executed by the processor, cause the client device to at least:
detect a trigger event for preloading a user wallet with a recommended credential for a predicted future use, the trigger event corresponding to at least one of a time of day, a date, a prior behavior, an opening of the user wallet, or transaction data;
identify the recommended credential based at least in part on at least one of user data, terminal data, credential data, or location data;
generate a payload for presenting the recommended credential to a terminal at a time of the predicted future use; and
store the payload in the user wallet;
establish a direct wireless communication channel between the client device and a transaction terminal; and
transfer the payload associated with the recommended credential to the transaction terminal via the direct wireless communication channel.

2. The system of claim 1, wherein the machine-readable instructions further cause the client device to at least:
generate input data based at least in part on the user data, the terminal data, the credential data, or the location data;
apply the input data to a trained recommendation model; and
obtain an output from the trained recommendation model, the recommended credential being identified based at least in part on the output of the trained recommendation model.

3. The system of claim 1, wherein the machine-readable instructions further cause the client device to at least:
send at least one of the user data, the terminal data, the credential data, or the location data to a backend computing device; and
receive an output response from the backend computing device, the output response corresponding to an output of a trained recommendation model, the recommended credential being identified based at least in part on the output response.

4. The system of claim 1, wherein the user data comprises at least one of transaction interaction history, behavior history, event data, user specified data, or loyalty engagement data.

5. The system of claim 1, wherein the credential data comprises at least one of credential type, credential identifier, or credential benefit data.

6. The system of claim 1, wherein the machine-readable instructions further cause the client device to at least:
query a distributed ledger for the terminal data, a query for the terminal data comprising at least one of location data or a terminal identifier.

7. The system of claim 1, wherein the machine-readable instructions further cause the client device to at least:
generate a user interface comprising a visual representation of the recommended credential; and
render the user interface in response to a user interaction with the user wallet of the client device.

8. The system of claim 1, wherein the machine-readable instructions further cause the client device to at least:
authenticate a user interacting with a wallet application of the client device; and
transmit the recommended credential to a terminal in response to the client device establishing a direct wireless connection with the terminal.

9. A method, comprising:
detecting a trigger event in response to monitoring at least one of client device data or user interaction data, the trigger event corresponding to a least one of a time, a date, a prior behavior, an opening of a user wallet, or transaction data;
generating input data based at least in part on user data, terminal data, credential data, and location data;
applying the input data to a trained recommendation model; and
identifying a recommended credential to preload in a wallet for a predicted future use based at least in part on an output of the trained recommendation model;
generating payload data corresponding to the recommended credential;
establishing a direct wireless communication channel with a transaction terminal; and
transferring the payload data associated with the recommended credential to the transaction terminal via the direct wireless communication channel.

10. The method of claim 9, further comprising receiving context data from a client device based at least in part on the trigger event, the context data comprising at least one of the user data, the terminal data, the credential data, or the location data.

11. The method of claim 9, further comprising querying a distributed ledger to obtain the terminal data, query comprising at least a terminal identifier or the location data.

12. The method of claim 9, obtaining the trained recommendation model from a backend computing device.

13. The method of claim 9, further comprising generating recommended payload data based at least in part on the recommended credential.

14. (canceled)

15. A non-transitory, computer-readable medium, comprising machine-readable instructions that, when executed by a processor of a client device, cause the client device to at least:
detect a trigger event in response to monitoring at least one of client device data or user interaction data, the trigger event corresponding to a least one of a time, a date, a prior behavior, an opening of a user wallet, or transaction data;
identify a recommended credential based at least in part on an output of a trained recommendation model;
store payload data associated with the recommended credential in a wallet to preload the wallet with the recommended credential;
establish a direct wireless communication channel between the client device and a terminal; and
transmit the payload data to the terminal in response to establishing the direct wireless communication channel with the terminal.

16. The non-transitory, computer-readable medium of claim 15, wherein the machine-readable instructions, when executed by the processor, further cause the client device to at least generate the payload data, the payload data being configured for transmission to the terminal via the direct wireless communication channel.

17. The non-transitory, computer-readable medium of claim 15, wherein the machine-readable instructions, when executed by the processor, further cause the client device to at least:
send a recommendation request to a computing device for the recommended credential; and
receive the output of the trained recommendation model from the computing device.

18. The non-transitory, computer-readable medium of claim 15, wherein the machine-readable instructions, when executed by the processor, further cause the client device to at least generate input data comprising user data, terminal data, and location data.

19. The non-transitory, computer-readable medium of claim 18, wherein the machine-readable instructions, when executed by the processor, further cause the client device to at least apply the input data to the trained recommendation model.

20. The non-transitory, computer-readable medium of claim 15, wherein the machine-readable instructions, when executed by the processor, further cause the client device to at least authenticate a user associated with the recommended credential prior to transferring the recommended credential to the terminal.

21. The system of claim 1, wherein the direct wireless communication channel comprises a near-field communication (NFC) channel, and the payload comprises a NFC compliant tag that generated to be compliant with payload standards of the NFC channel.
